(19) United States
(12) Patent Application Publication
(10) Pub. No.: US 2004/0033052 A1
(43) Pub. Date: Feb. 19, 2004

(54) PC-based digital video recorder system with a plurality of USB cameras

(76) Inventors: In-Keon Lim, Seoul (KR); In-Hyo Jeong, Yong-In City (KR); Jin-Seop Kim, Suwon City (KR); Dae-Joong Kim, Suwon City (KR)

Correspondence Address: VOLENTINE FRANCOS, P.L.L.C., Suite 150, 12200 Sunrise Valley Drive, Reston, VA, 20191, US

(21) Appl. No.: 10/641,014

(22) Filed: Aug. 15, 2003

Related U.S. Application Data
(63) Continuation of application No. PCT/KR02/00868, filed on May 10, 2002.

(30) Foreign Application Priority Data
May 14, 2001 (KR) 10-2001-0026052

(51) Int. Cl. H04N 5/781

(52) U.S. Cl. 386/46; 386/125

(57) ABSTRACT

A PC-based digital video recorder (DVR) system for security and surveillance includes a plurality of USB cameras connected to at least one USB port of a computer by fiber-optic extension cables and USB hubs. The cameras may be cascaded to operate up to 50 meters from the computer. The system processes the digital image data of multiple-channels broadcast from the plurality of cascaded USB cameras.

### CROSS REFERENCES TO RELATED APPLICATIONS

This application is a continuation of International Application No. PCT/KR02/00868, filed on May 10, 2002, and claims priority under 35 U.S.C. § 119 from Korean Patent Application No. 2001-0026052, filed on May 14, 2001, and the contents of each of which are hereby incorporated by reference in their entirety for all purposes as if fully set forth herein.

### BACKGROUND AND SUMMARY

Field of the Invention

The present invention relates to PC-based digital video recorder system with multiple Universal Serial Bus (USB) cameras, and more particularly to a digital video recorder system that is conveniently applicable to a security and surveillance system with reduced cost by cascading a plurality of USB cameras at distances of up to 50 meters.

As the industrial structure becomes complicated, a application area of a security and surveillance system monitoring buildings and offices has been expanded. The digital video recorder (DVR) system is currently used for the surveillance of buildings, underground parking lots, service desks at the bank, and automatic teller machines (ATM).

FIG. 1 shows a DVR having a the main computer unit 100, for storing a digital image, having connections with multiple analog Charge Coupled Device (CCD) cameras 121, 122, 123 through coaxial cables 140, 141, 142, 143.

The images that are captured by each of the CCD cameras 121, 122, 123 are processed by a hardware device, which is called a capture board 110.

The DVR system of FIG. 1, however, has a shortcoming in that each CCD camera monitoring the security of a specific area should have its own separate power supply 130, 131, 132, 133.

Meanwhile, the capture board 110, which is often called as an encoder when a chip for digital image compression is included, comprises a capture chip. The capture chip captures the image data that is sent from an analog CCD camera and stores the image data in the memory through the PCI bus. In this case, the storing process in the memory through the PCI bus is controlled by a DMA (direct memory access) controller.

Thereafter, the image data stored in the memory is accessed by a central processing unit and compressed for digital data storage.

In case of the such a DVR, it is necessary to provide a device driver in order to administrate the DMA that stores the digital image sent from the capture chip through the PCI bus.

In other words, since the device driver is a software interface that receives the data from the capture chip through the PCI bus, it is inconvenient to provide the device driver additionally for implementing the DVR.

In an effort to resolve the problem of the conventional DVR system having analog CCD cameras, an approach has been suggested that employs USB cameras.

The DVR system equipped with USB cameras, however, suffers from a limitation in practical applications because of the technical problems associated with cascading a plurality USB cameras at more than 5 meters distance.

Consequently, the USB camera is usually employed only for personal usage, e.g., a chat camera on the Internet.

Accordingly, it would be desirable to provide a DVR system that can be operated with a plurality of USB cameras in cascade.

It is would also be desirable to provide a DVR system that reduces the cost for the installation by either cascading or directly connecting multiple USB cameras.

It would further be desirable to provide a PC-based DVR system that can be operated even without a capture board.

It would be still further be desirable to provide a DVR system that does not require the additional development of the device driver for processing the image data sent from the recording cameras.

In accordance with a broad aspect of the present invention, provided is a DVR system configuring multiple USB cameras, either by cascade or by direct connection.

As disclosed in greater detail below, the PC-based DVR with the WINDOWS® operating system and multiple USB cameras resolves the issue of the connection distance limit of less than 5 meters, which is due to the voltage drop along the USB cable.

This makes it possible to install multiple USB cameras at up to 50 meters from the USB port of the computer by employing a fiber-optic extension cable and a USB hub, either for cascade or for fiber-optic extension.

### BRIEF DESCRIPTION OF THE DRAWINGS

Further features of the present invention will become apparent from a description of the present invention in conjunction with the accompanying drawings of a preferred embodiment of the invention, which, however, should not be taken to be limitative of the invention, but are for explanation and understanding only.

In the drawings:

FIG. 1 is a schematic diagram illustrating the configuration of a DVR system.

FIGS. 2A and 2B are schematic diagrams illustrating the configuration of the DVR system in accordance with a first embodiment.

FIG. 3 is a schematic diagram illustrating a fiber-optic extension cable for USB cameras.

FIG. 4 is a schematic diagram of the DVR system in accordance with a second embodiment.

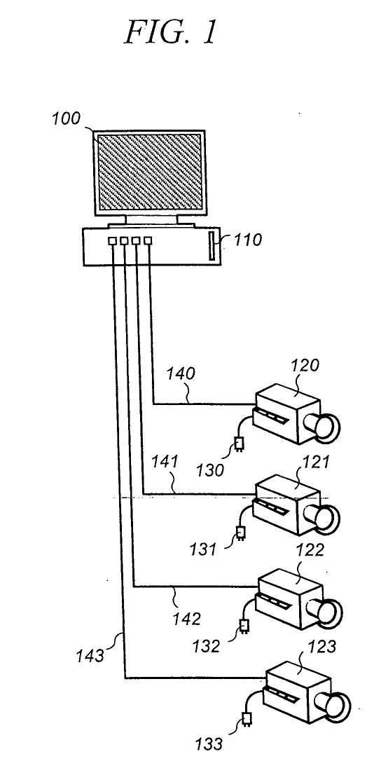

### DETAILED DESCRIPTION OF THE INVENTION

The present invention will be explained in detail with reference to the accompanying drawings.

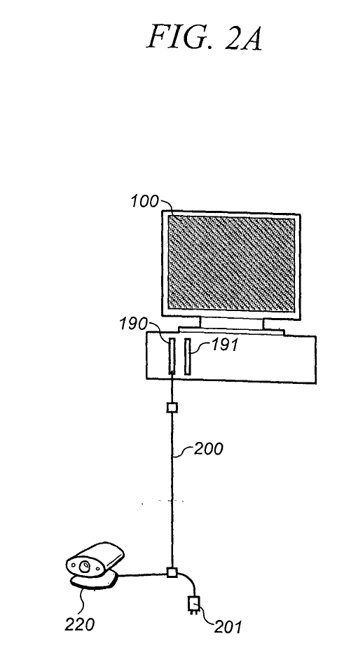

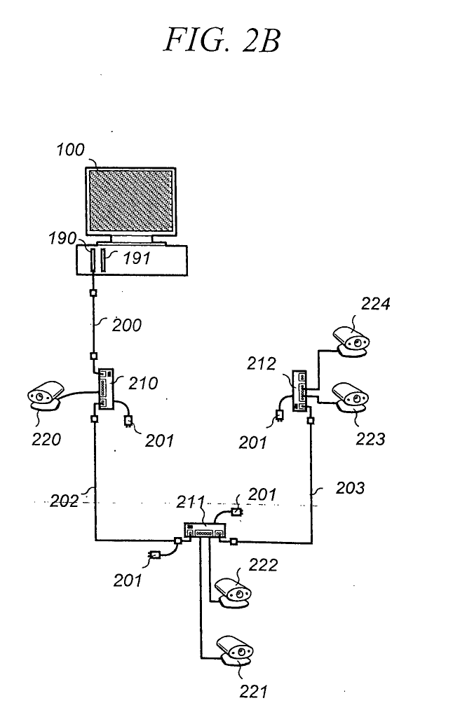

FIGS. 2A and 2B are schematic diagrams illustrating the configuration of the DVR system in accordance with a first embodiment.

Referring to FIG. 2A, the fiber-optic extension cable 200 for a USB port of a personal computer 100 enables the computer to communicate with USB cameras 220 located up to 50 meters away.

A first embodiment, as depicted in FIG. 2B, has a feature that since the DVR system comprises a plurality of USB cameras connected to a personal computer with the WINDOWS® operating system, which provides a USB application programming interface (API), it is possible to build a device-independent DVR system that can process the digital image data sent from the USB cameras irrespective of the various brand of USB cameras.

Meanwhile, USB is a plug-and-play interface between a computer and addon devices such as audio players, keyboards, and cameras. With USB, a new device can be added to a computer without having to add an adapter card or even having to turn the computer off. The maximum length of the USB cable, however, is limited to only up to 5 meters for safe USB communication.

Accordingly, as disclosed herein, a fiber-optic extension cable 200 is introduced for a USB network.

Referring to FIGS. 2A and 2B, a fiber-optic extension cable 200 for a USB network preferably can be linked to the USB ports 190, 191 at the back of a personal computer.

The fiber-optic extension cable 200 for a USB interface comprises a transceiver for converting the USB electrical signal into an optical signal and vice versa and thereby extends the effective communication distance between the computer and an add-on device up to 50 meters.

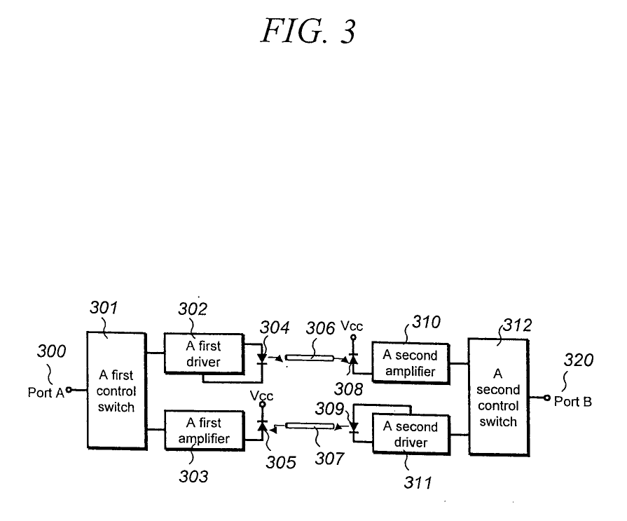

The detailed description of the fiber-optic extension cable will be presented with reference to FIG. 3 later, and the functional block of the DVR system is described in detail with reference to FIG. 2B.

Referring to FIG. 2B again, electrical power 201 is provided at an end of the fiber-optic extension cable 200 for a USB interface and the USB hub 210 enables multiple USB cameras to be connected.

Beneficially, the USB hub 210 can be supplied with electrical power independently. A plurality of USB ports are provided at the USB hub 210, as shown in FIG. 2B, and each USB camera is linked to one of the USB ports of the USB hub 210.

In addition, when the DVR system is applied to the security and surveillance system, it is necessary to compress and store the digital image data sent from a plurality of USB cameras that are installed here and there for the security.

For security applications, the fiber-optic extension cable 202 for a USB interface can be linked to the USB hub 210 in a cascade connection and thereby a plurality of USB cameras 221, 222 can be connected via USB hub 211.

Consequently, it is possible to cascade a plurality of USB cameras 220, 221, 222, 223, 224 by employing a plurality of USB hubs 210, 211, 212 and a plurality of fiber-optic extension cables 200, 202, 203 for a USB interface.

Preferably, the distance between the USB port 190, 191 and the USB camera 224 at the destination of the fiber-optic extension cable 200, 202, 203 should not go over a reliable communication distance, e.g. 50 meters.

As a consequence, such a system resolves the complexity of the configuration of analog CCD cameras connected to a computer with many corresponding ports by employing only one USB port 190 with multiple USB cameras 220, 221, 222, 223, 224.

This makes it possible for up to 127 USB cameras to be connected to a single USB port 190, and furthermore has a feature in a sense that the cost as well as the installation time can be reduced because of the simplicity in cascading the abovementioned 127 channels in a serial connection.

Once the USB device driver program, which is provided with the MICROSOFT® WINDOWS® operating system, is installed in the PC-based DVR system with USB cameras, neither additional hardware such as a capture board, nor a capture chip nor software including a device driver for specific brand of camera is required.

FIG. 3 is a schematic diagram illustrating a configuration of a fiber-optic cable for a USB interface. The USB bus comprises a Vcc power line of +5 volts, a ground line, a D+ data line, and a D− data line.

Referring to FIG. 3, either the D+ terminal or the D− terminal of the port A of the USB is connected to a first control switch 301, and a first driver 302 drives the light-emitting diode 304 corresponding to the electric signal from the port A 300 for transmitting light signals through the fiber-optic cable 306.

The optical signal is detected at a photodiode 308 and transmitted to a second control switch 312 after being converted into an electric signal by a second amplifier 310. Similarly, the USB signal from the port B 320 is transferred through a second driver 311 and a light-emitting diode 309 to a fiber-optic cable 307, and the optical data is extracted at the photodiode 305 to be sent to a first amplifier 303 and a first control switch 301.

Beneficially, a conventional cable can be used in place of the fiber-optic extension cable. A detailed description for the fiber-optic extension cable can be found with reference to the bulletin of the Korean patent laid-open application No. 2001-0016359, the contents of which are hereby incorporated herein by reference in their entirety as if fully set forth herein.

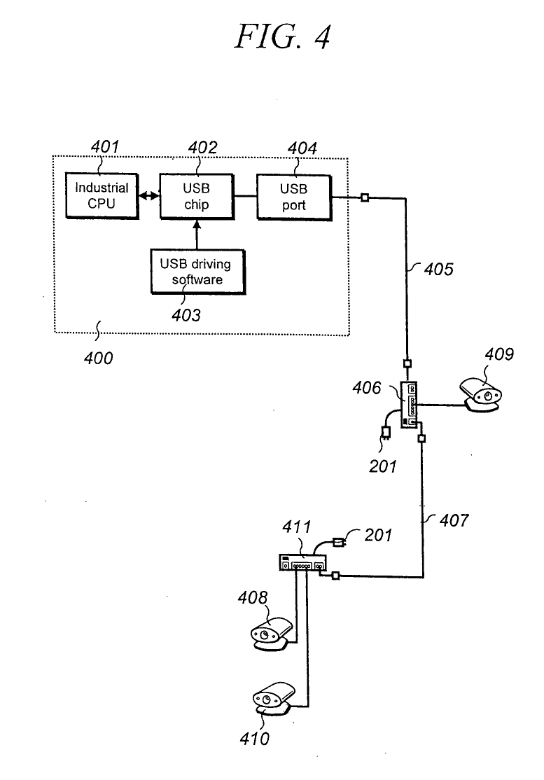

FIG. 4 is a schematic diagram illustrating the configuration of a DVR system in accordance with a second embodiment. The second embodiment provides an embedded DVR system that employs an industrial CPU with its own real-time operating system for the installation of a plurality of USB cameras.

Referring to FIG. 4, an industrial CPU 401, a USB chip 402, and a USB port 404 are shown. In this case, a USB driver program should be provided.

In the meanwhile, a plurality of USB cameras 408, 409, 410 can be connected to the USB port 404 via the fiber-optic extension cables 405, 407 and a plurality of USB ports 406, 411 by cascade or direct connection.

Although the invention has been illustrated and described with respect to exemplary embodiments thereof, it should be understood by those skilled in the art that various other changes, omissions and additions may be made therein and thereto, without departing from the spirit and scope of the present invention.

Therefore, the present invention should not be understood as limited to the specific embodiments set forth above but to include all possible embodiments which can be embodied within a scope encompassed the appended claims, and equivalents thereof.

Finally, the present invention makes it possible to implement a digital video recorder system with multiple USB cameras cascaded over 5 meters, and indeed up to 50 meters, by employing the fiber-optic extension cable and a USB hub, if any, without additional hardware like a capture board, a separate device driver program.

As a consequence, the installation cost as well as the price of the DVR system can be tremendously reduced because the price of the USB camera is cheaper than that of the conventional analog CCD camera by more than a fourth.

We claim:

1. A PC-based digital video recorder (DVR), comprising:
a computer, which is installed with WINDOWS® operating system, having at least one USB port;
a first fiber-optic extension cable for a USB interface, having an interface module which converts an electrical signal into an optical signal and vice versa; and
a plurality of USB cameras connected to said USB port, and each said USB camera providing digital image data to said USB port, through said fiber-optic extension cable; and
one of a group consisting of a USB hub and a second fiber-optic extension cable for a USB interface, connected between at least one of said USB cameras and said first fiber-optic extension cable for a USB interface.

2. The PC-based DVR system of claim 1 wherein said WINDOWS® operating system includes an application program interface (API).

3. The PC-based DVR system of claim 1 wherein said computer that processes the digital image data sent from said USB camera without any capture board in hardware.

4. The PC-based DVR system of claim 1 wherein said USB hub includes a plurality of terminals, each of said terminals being connected to one of a group consisting of: said plurality of USB cameras; said first fiber-optic extension cable; and a USB cable.

5. The PC-based DVR system of claim 4 wherein:
a first terminal among said plurality of terminals of said USB hub is connected to one from the group consisting of: said USB port, a cable connected to said USB port, a fiber-optic extension cable for a USB interface connected to said USB port;
a second terminal among said plurality of terminals of said USB hub is connected to said one USB camera; and
a third terminal among said plurality of terminals of said USB hub is connected to a second one of the plurality of USB cameras by one selected from the group consisting of a cable and a fiber-optic extension cable for a USB interface.

6. The PC-based DVR system of claim 1, wherein a distance between the USB port and a farthest located USB camera lies within an effective distance of data communication without failure.

7. The PC-based DVR system of claim 1, wherein the distance between the USB port and a farthest located USB camera is greater than five meters.

8. A PC-based digital video recorder (DVR) system, comprising:
a computer, including:
at least one universal serial bus (USB) port;
a USB integrated circuit processing USB data communicated through said USB port;
a central processing unit (CPU), driving a real-time operating system (OS) and said USB integrated circuit;
a first fiber-optic extension cable for a USB interface having an interface module which converts an electrical signal into optical signal and vice versa connected between the USB port and the image capturing cameras; and
a plurality of USB cameras, each of said USB cameras being connected to said USB port either directly or through said first fiber-optic extension cable;
at least one of a USB hub or a second fiber-optic extension cable for a USB interface, connected between at least one of said USB cameras and said USB port; and
a storage means storing a driver program for driving said USB cameras.

9. The PC-based DVR system of claim 8 wherein said USB hub includes a plurality of terminals

10. The PC-based DVR system of claim 9 wherein:
a first terminal among said plurality of terminals of said USB hub is connected to one from the group consisting of: said USB port, a cable connected to said USB port, a fiber-optic extension cable for a USB interface connected to said USB port;
a second terminal among said plurality of terminals of said USB hub is connected to said one USB camera; and
a third terminal among said plurality of terminals of said USB hub is connected to a second one of the plurality of USB cameras by one selected from the group consisting of a cable and a fiber-optic extension cable for a USB interface.

11. The PC-based DVR system of claim 8, wherein a distance between the USB port and a farthest located USB camera lies within an effective distance of data communication without failure.

12. The PC-based DVR system of claim 8, wherein the distance between the USB port and a farthest located USB camera is greater than five meters.
